(19) United States
(12) Patent Application Publication
(10) Pub. No.: US 2009/0012831 A1
(43) Pub. Date: Jan. 8, 2009

(54) SYSTEM AND METHOD FOR ASSESSING WORKPLACE SAFETY

(75) Inventors: Paul John Grant, Bangkok (TH); Lewis Michael Senior, Alicante (ES)

Correspondence Address: KNOBBE MARTENS OLSON & BEAR LLP, 2040 MAIN STREET, FOURTEENTH FLOOR, IRVINE, CA, 92614, US

(73) Assignee: CPD INTERNATIONAL SERVICES PTE. LTD.

(21) Appl. No.: 12/233,505

(22) Filed: Sep. 18, 2008

Related U.S. Application Data
(63) Continuation of application No. PCT/SG2007/000074, filed on Mar. 16, 2007.

(51) Int. Cl. G06Q 90/00

(52) U.S. Cl. 705/7; 700/30

(57) ABSTRACT

A system and method for assessing workplace safety are disclosed herein. In one embodiment, the system comprises a memory device configured to store data comprising at least one first set of data comprising information indicative of at least one worker's adherence to predetermined safety procedures and information indicative of a first assessor bias, and at least one second set of data comprising information indicative of at least one workplace environmental parameter and information indicative of a second assessor bias, and a computer processor electrically connected to the memory device and configured to analyze the data stored in the memory device based on the information indicative of the first and second assessor biases.

### CROSS-REFERENCE TO RELATED APPLICATIONS

This application is a continuation, and claims the benefit under 35 U.S.C. §§120 and 365 of PCT Application No. PCT/SG2007/000074, filed on Mar. 16, 2007, which is hereby incorporated by reference in its entirety.

### BACKGROUND

1. Field

The present invention relates to methods, systems and apparatus for assessing safety and in particular for assessing workplace safety.

2. Description of the Related Technology

Many workplace sites, including construction and manufacturing sites, oil drilling rigs and so on involve the use of equipment, tools and machinery to be operated by several workplace personnel, or “workers”. Such workplace environments involve potential safety issues relating to correct use of equipment, tools and machinery by workers, and correct equipment maintenance, to prevent injury to workers.

Several companies have devised systems to assess and audit the safety of workplaces to prevent accidents and injury to workers. An example of one system is the “Safety Training Observation Program”, or “STOP™” by E. I. du Pont de Nemours and Company (DuPont). STOP™ involves training workers to carry out daily audits of their workplace using a standard “observation checklist” questionnaire which may be filled out by a worker. By answering the questions, the worker carries out a safety audit of the workplace. The questions may be adapted to suit the specific equipment and environment of the workplace in question, however they include questions relating to reactions of people to specified situations, use of specified personal protective equipment, positions/locations of workers in relation to machinery, whether tools and equipment being used for a particular purpose are appropriate for that purpose, whether correct procedures are being followed, etc. The results of questionnaires filled out by several workers are then collated for later reporting and, where applicable, action for improving workplace safety.

### SUMMARY

One aspect of the invention is a computerized method of assessing workplace safety, the method comprising receiving at least one first set of data, each first set of data comprising information indicative of at least one worker's adherence to predetermined safety procedures and further comprising information indicative of a first assessor bias, receiving at least one second set of data from a second memory device, each second set of data comprising information indicative of at least one workplace environmental parameter and further comprising information indicative of a second assessor bias, and analyzing the received data based on the information indicative of the first and second assessor biases.

Another aspect of the invention is a system for assessing workplace safety, the system comprising a memory device configured to store data comprising at least one first set of data comprising information indicative of at least one worker's adherence to predetermined safety procedures and information indicative of a first assessor bias, and at least one second set of data comprising information indicative of at least one workplace environmental parameter and information indicative of a second assessor bias, and a computer processor electrically connected to the memory device and configured to analyze the data stored in the memory device based on the information indicative of the first and second assessor biases.

Another aspect of the invention is a computer-readable medium for storing at least one computer program for performing a method of assessing workplace safety, the method comprising receiving at least one first set of data from a first memory device, each first set of data comprising information indicative of at least one worker's adherence to predetermined safety procedures and further comprising information indicative of a first assessor bias, receiving at least one second set of data from a second memory device, each second set of data comprising information indicative of at least one workplace environmental parameter and further comprising information indicative of a second assessor bias, and analyzing the received data based on the information indicative of the first and second assessor biases.

### BRIEF DESCRIPTION OF THE DRAWINGS

FIGS. 1a to 1c are flow diagrams of steps of an embodiment of the invention.

FIGS. 2a and 2b are schematic diagrams of an embodiment of data cards according to one aspect of the invention.

FIG. 3 is a schematic diagram of an embodiment of a computer system.

### DETAILED DESCRIPTION OF CERTAIN EMBODIMENTS

One embodiment of the invention comprises a method and system for assessing workplace safety for helping an organization reduce or prevent workplace accidents and injury, and downtime associated therewith. The method and system may be useful in work environments where heavy machinery is operated, such as in a manufacturing plant or on an oil platform, and where there are several workers who may or may not work in shifts. Some embodiment of the invention ensure a formalized safety assessment program is in place to reduce and prevent workplace injury and accidents. Some embodiments of the invention make use of the above mentioned inventive realization that workplace safety can be better assessed and managed if different personalities of workers are acknowledged and utilized in assessing workplace safety and in using the assessment results to improve workplace safety.

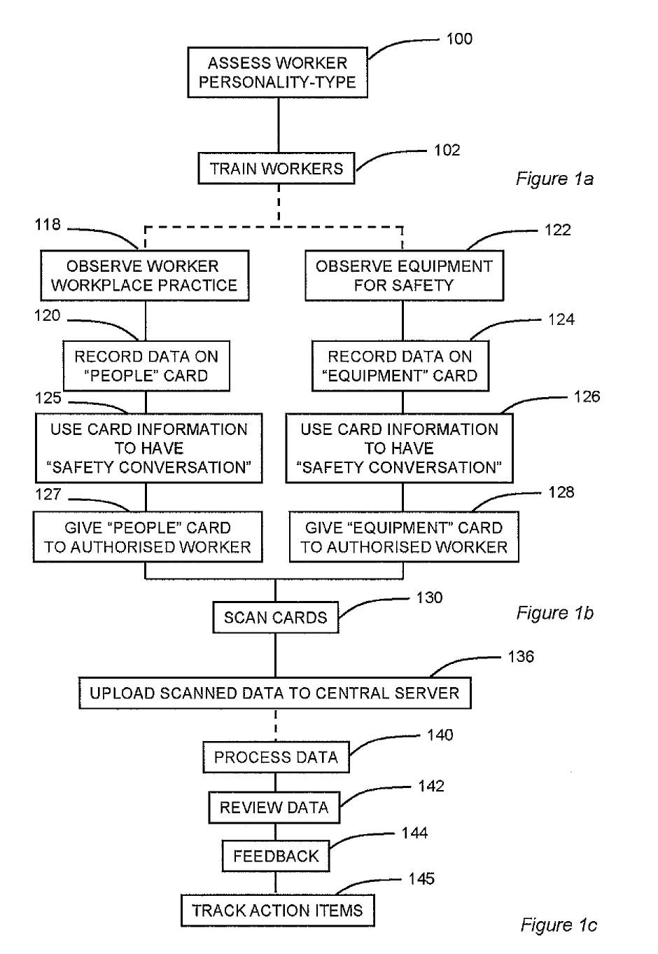

Referring to FIGS. 1a to 1c, in one embodiment, the method comprises three main stages, each shown schematically joined in FIGS. 1a to 1c by dotted lines. Firstly, referring to FIG. 1a, at least some and, in some embodiments, all workers are assessed 100 for their personality-type using a personality indicator test. Personality indicator tests which could be used with some embodiments include such tests as those based on, or influenced by, either wholly or in part, known Jungian personality types (“thinking, feeling, sensing and intuiting”). One example of such tests includes the applicant's “E-Colors” personality test which attempts to predict a person's behavior depending on different situations. The test is used to determine the weighting of an individual's personality in terms of four personality traits: director—doer, direct communicator who is task orientated; influencer—talker, sociable and people orientated; supportive—guardian, team player and people orientated; and analytical—thinker, detailed and task orientated. The applicant has determined that most people will have a dominant pair of personality traits, typically being either the pair of director and analytical (indicating a “task-orientated” personality), and the pair of influencer and supportive (indicating a “people-orientated” personality). Each of the assessed workers is given indicia in the form of a marked label to locate visibly on their person, such as on their hardhat, or shoulder, so that their co-workers can see the label. In this embodiment, the markings on the label include two colors: a first color to indicate the worker's predominant personality trait; and a second color to indicate the worker's second dominant personality trait. For most, if not all workers, their label will include colors indicating either the pair of task-based personality traits or colors indicating the pair of people-based personality traits. As will become more evident in the following description, this embodiment utilizes the knowledge of the worker's personality traits and the indicators in assessing and improving workplace safety. Also, as will be understood, in an alternative embodiment, indicia other than color may be used to indicate personality traits, for example, unique symbols, alphanumeric symbols, etc may be used. Also, alternatively, in place of two colors, the label may only comprise one color (or other indicia) to indicate the worker is task-orientated and one color (or other indicia) to indicate the worker is people-orientated.

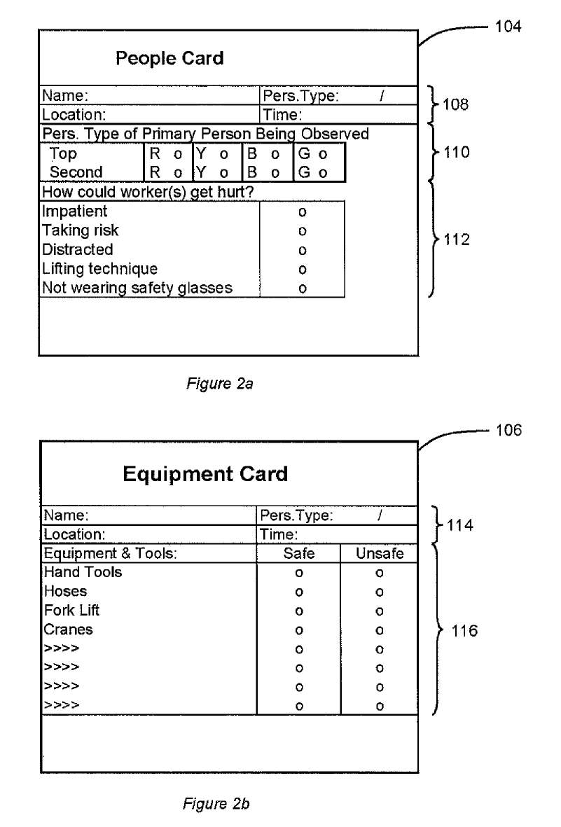

Once workers have been assessed for their personality traits, they are trained 102 in how to use a method of the present embodiment. Referring to FIGS. 2a and 2b, this involves training workers how to use a first data recorder in the form of a first data card 104 for recording data regarding worker safety in terms of workers' adherence to safety procedures, and how to use a second data recorder in the form of a second data card 106 for recording data regarding equipment safety. In this embodiment, the first data card 104 is arranged in three sections: a first section 108 relating to the worker carrying out the assessment; a second section 110 regarding the personality of the primary worker being assessed; and a third section 112 with questions relating to predetermined worker safety procedures. The first section 108 includes data recording space for the assessing worker to record details such as their name, personality type (in the form of their two predominant colors), location and the time of day. The second section 110 provides space for recording the personality of the primary of their co-workers they are assessing (for example, a group of co-workers may be performing a task: only one or a representative one of the group will be considered in completing the card 104). As each worker wears a visible label on their person indicating their personality-type, this facilitates the recording of the primary worker's personality-type on the first data card 104. In this embodiment, the four letters in the second section 110 relate to colors which indicate the above four mentioned personality types. “R” represents red, as an indicator of the “Director” personality type. “Y” represents yellow, as an indicator of the “Influencer” personality type. “B” represents blue, as an indicator of the “Supportive” personality type. “G” represents green, as an indicator of the “Analytical” personality type. The third section 112 comprises several questions regarding how the workers being observed could get hurt, depending on their current work practice. For those questions provided in the third section 112 which require a positive response, the worker assessing the worker safety marks the relevant circle to indicate there is a safety problem or potential safety problem. As will be understood, more or fewer questions may be included on the first data card 104. In this embodiment, the second data card 106 comprises an equivalent first section 114 to the first section 108 on the first data card 104 and a second section 116 comprising questions relating to the safety or otherwise of equipment and tools. In the embodiment, illustrated in FIG. 2b, eight questions are provided (four actual questions are provided in the illustrated example, with symbols “>>>>” given to illustrate space for four additional questions) for a worker assessing worker safety to record the safety or otherwise of either items of equipment or tools. As will be understood, more or fewer questions may be provided in the second section 116 of the card 106.

Referring to FIG. 1b, a worker equipped with a set of first and second data cards 104, 106, who is also trained 102 in how to use the cards, can assess, separately, the workplace safety of their co-workers in terms of how they are carrying out predetermined worker safety procedures and in terms of whether equipment and/or tools meet predetermined safety parameter requirements. The assessment is carried out by the worker in question by observing 118 worker workplace practice and following and recording 120 responses to the questions on the first data card 104. Once the worker has responded to as many questions on the first card 104 as relevant, he then observes 122 the workplace equipment and tools and, following the questions on the second data card 106, records 124 relevant data on the second data card. As will be understood, the worker may observe either the worker workplace practice 118 prior to observing equipment safety 122, or vice versa.

By having separate first and second data cards 104, 106, the worker performing the workplace safety assessment is forced to separate his consideration of worker adherence to safety procedures and of safety of equipment. As explained above, given the natural bias of task-orientated people toward consideration of equipment safety and of people-orientated people toward the way people perform their work, this separation may function to reduce bias by workers when performing workplace safety assessments.

Once observations are made on either equipment 118 and/or people 122, the observer using either the first data card 104 or the second data card 106 may have a safety conversation 125 with the co-worker(s) being observed in relation to the first data card 104 to discuss both safe and unsafe observations, or he may have a safety conversation 126 with co-workers responsible for the equipment which is the subject of the second data card 106.

Once the worker has completed his assessment of worker workplace practice and equipment safety, he may give 127, 128 his completed cards 104, 106 to a designated authorized co-worker. As will be understood, more than one or all workers in a given workplace may perform the above described method at regular or ad hoc time intervals, as determined by the employer of the workers.

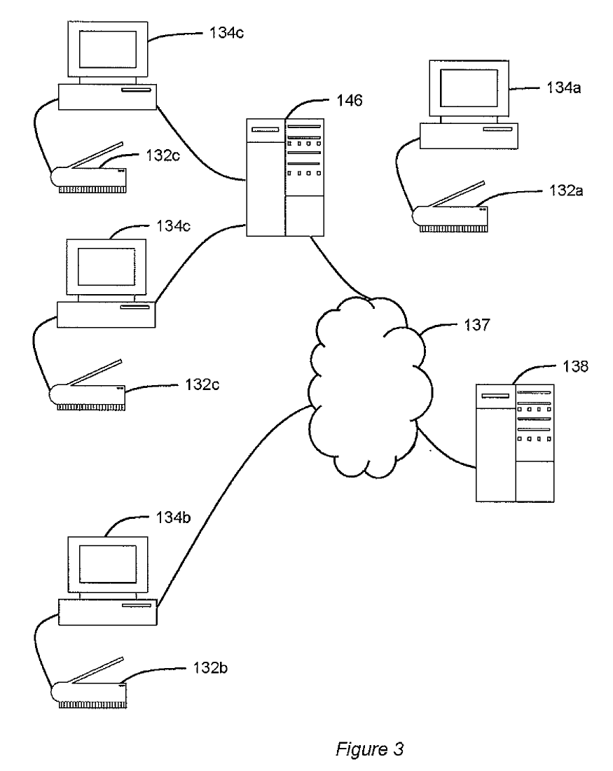

The collected cards may be singly or batch scanned 130 by a standard optical scanning device 132a,b,c (see FIG. 3) to a computer 134a,b,c. Software on the computer 134 determines responses to the questions, since the cards 104, 106 are in a format wherein a software program, written with the cards 104, 106 and question format in mind, determines the responses to the questions. In one embodiment, optical character recognition (OCR) software is also used to determine the respective worker's names and personality types written on the cards 104, 106. An image of each card is held in the computer's memory for later recollection. The data determined by the software, after the scanning of the cards, is then uploaded 136 via a network, such as a local area network (LAN), wide area network (WAN), the internet 137, or other network to a central server 138. In an embodiment where the first and second cards 104, 106 are double sided, the scanner may be configured to scan both sides of the cards at once to reduce manual input and time taken to scan the cards.

As will be understood, the above described method and system may be implemented at several workplace locations of an organization. Therefore, it may be useful to be able to upload the data determined from the scanning process to a central server or computer 138 belonging to the organization to centrally assess the workplace safety of their organization as a whole, or workplace by workplace, for example.

Referring to FIG. 1c, the uploaded data is then processed 140 by the central computer 138. The processing provided by software includes the providing of collected responses to each question, which may then be provided to a user, such as a manager of the organization, in the form of a table or graph, as desired. From this, the user can review 142 the data relating to the workplace safety of his workers based on procedural adherence by workers and on equipment. Furthermore, the software may be configured to allow the user to review portions of the data, such as the compiled data recorded by all workers having the same personality-type. In this way, the user can identify if one personality-type group is more aware of some workplace safety issues than their co-workers. Also, the software may be configured to allow the user to review collated equipment data and collated worker procedural safety data for each location to determine whether one location has more or less potential for an accident or worker injury in terms of equipment safety and/or worker procedural safety. Once the data has been reviewed 142 by the user, feedback 144 may be given to one or more or each location of the organization for improving the safety at those locations, and improvements noted for action and tracked for implementation 145. As will be understood, the steps exemplified in FIG. 1b may continue to take place independently of the steps exemplified in FIGS. 1a and 1c. Once feedback 144 has been implemented, it may then be possible for the user to monitor the impact of the feedback or of the actioned improvements through the processing 140 and review 142 of data collected through the steps in FIG. 1b after feedback implementation.

The steps illustrated in FIG. 1c have been briefly described in terms of a computer system including a scanner, computer and internet uplink to a central computer for processing of scanned data. Referring to FIG. 3, this may be achieved in several ways. Firstly, for example where the organization has one workplace, the scanner and computer may be stand-alone, as illustrated by scanner 132a and computer 134a. In this embodiment, the computer 134a itself may contain the software for processing 140 the scanned data for later review 142 by the user. Alternatively, as illustrated by scanners 132b,c and computers 134b,c, the organization may comprise a first location with one scanner 132b and computer 134b combination connected through the internet 137 to a central computer 138 for data processing 140, etc. At another location, there may be more than one scanner 132c and associated computer 134c connected via a LAN or WAN to a local central server computer 146 which is in turn connected via the internet 137 to a central server computer 138. In this embodiment, the data processing 140 may be performed by one or more of the computers 134c, the local central server computer 146 or the central server computer 138, depending on the desired outcome of the organization. For example, where a user at one location (such as the location served by computer 134b) wishes to review 142 processed data for his location, it may be useful for the data to be processed at his location. The processed data may then also be uploaded to the central computer server 138, for review 142 by another user in the organization. As will be understood, other known computer network configurations may be used for the process, review, upload or download of raw scanned data or processed data, depending on the needs of the organization.

In an alternative embodiment, as an addition to the above described process 140 and review 142 steps, the software may be configured to weight the collated recorded data depending on the personality-type of the workers having recorded the data. In this way, more weight can be applied to equipment safety data recorded by task-orientated personality-type workers, and more weight can be applied to worker procedural adherence safety data recorded by people-orientated personality-type workers.

In another embodiment, as an addition to the above described process 140 and review 142 steps, the data from the first card 104 may be processed by the computer 138 to determine whether workers of a particular personality-type appear to be more or less safe than their colleagues in terms of adherence to safety practices. This information can allow for the training step 102 can be tailored for each personality-type. This may help to influence workers' adherence to workplace safety practices.

Another embodiment comprises a set of first and second cards 104, 106, comprising the features described above, wherein the set is containable in a card wallet. The set may be used in conjunction with the above described method and system embodiments. The card wallet is arranged to hold a plurality of the first cards 104 together and a plurality of the second cards 106 together, separately from the plurality of first cards 104. The set is provided in a convenient size to be carried by a worker at their workplace to allow for easy and at least partially protected carrying of the first and second cards 104, 106 by the worker.

The use of labels to display the personality types of workers may reduce adverse safety incidents in the workplace. As an optional addition to the step of training workers 102, the workers can also be trained in how to interact with their colleagues dependent on their co-workers' personality-types. This can be particularly helpful when having the safety conversation 125 mentioned above with co-workers in relation to how they are performing their work, or when having a safety conversation 126 mentioned above with co-workers who are responsible for equipment. With knowledge of their co-worker's personality-type, they can approach their co-worker in a manner that is either less likely to offend or upset their co-worker, and/or in a manner which is likely to achieve a positive result in improving their co-worker's adherence to workplace safety practice.

As will be understood, the present embodiment is also applicable to other work environments, including office work environments, storing and packing environments, and so on.

While the invention has been described in reference to particular embodiments, it is to be understood that the words which have been used are words of description rather than limitation and that changes may be made to the invention without departing from its scope as defined by the appended claims.

What is claimed is:

1. A computerized method of assessing workplace safety, the method comprising:
receiving at least one first set of data, each first set of data comprising information indicative of at least one worker's adherence to predetermined safety procedures and further comprising information indicative of a first assessor bias;
receiving at least one second set of data from a second memory device, each second set of data comprising information indicative of at least one workplace environmental parameter and further comprising information indicative of a second assessor bias; and
analyzing the received data based on the information indicative of the first and second assessor biases.

2. The method of claim 1, wherein the information indicative of at least one workplace environmental parameter comprises information indicative of adherence to at least one predetermined equipment safety parameter.

3. The method of claim 1, wherein at least one of the first and second assessor biases is indicative of a personality-type.

4. The method of claim 3, wherein the personality-type comprises at least one of a task-oriented personality-type or a people-oriented personality-type.

5. The method of claim 4, wherein the task-oriented personality-type comprises at least one of a director personality-type or an analytical personality-type, and wherein the people-oriented personality-type comprises at least one of an influencer personality-type or a supportive personality-type.

6. The method of claim 1, wherein observational tendencies are assessed in by a method in which more weight is accorded to a first set of data comprising information indicative of a first assessor bias indicating a people-oriented personality-type than is accorded to a first set of data comprising information indicative of a first assessor bias indicating a task-oriented personality-type.

7. The method of claim 1, wherein observational tendencies are assessed in by a method in which more weight is accorded to a second set of data comprising information indicative of a second assessor bias indicating a task-oriented personality-type than is accorded to a second set of data comprising information indicative of a second assessor bias indicating a people-oriented personality-type.

8. The method of claim 1, further comprising reporting results of analyzing the received data via a computer display.

9. The method of claim 1, wherein the first set of data further comprises information indicative of the personality-type of the at least one worker.

10. The method of claim 9, wherein analyzing the received data results in an indication of whether workers having a first personality-type work more or less safely than workers having a second personality-type.

11. The method of claim 9, wherein analyzing the received data results in an indication of whether workers having a first personality-type observe different conditions than workers having a second personality-type.

12. A system for assessing workplace safety, the system comprising:
a memory device configured to store data comprising at least one first set of data comprising information indicative of at least one worker's adherence to predetermined safety procedures and information indicative of a first assessor bias, and at least one second set of data comprising information indicative of at least one workplace environmental parameter and information indicative of a second assessor bias; and
a computer processor electrically connected to the memory device and configured to analyze the data stored in the memory device based on the information indicative of the first and second assessor biases.

13. The system of claim 12, further comprising a scanner configured to scan the data from a first and second data card into the memory device.

14. The system of claim 13, wherein the first data card comprises three sections, a first section comprising data relating to the assessor, a second section comprising data relating to the at least one worker, and a third section comprising data relating to the at least one worker's adherence to predetermined safety procedures.

15. The system of claim 14, wherein the data relating to the at least one worker comprises an indication of at least one personality-type.

16. The system of claim 15, wherein the computer processor is further configured to process the data stored in the memory device to provide an indication of whether workers having a first personality-type work more or less safely than workers having a second personality-type.

17. The system of claim 15, wherein the computer processor is further configured to process the data stored in the memory device to provide an indication of whether workers having a first personality-type observe different conditions than workers having a second personality-type.

18. The system of claim 12, wherein the information indicative of at least one workplace environmental parameter comprises information indicative of adherence to at least one predetermined equipment safety parameter.

19. The system of claim 12, wherein at least one of the first and second assessor biases is indicative of a personality-type.

20. The system of claim 19, wherein the personality-type comprises at least one of a task-oriented personality-type or a people-oriented personality-type.

21. The system of claim 20, wherein the task-oriented personality-type comprises at least one of a director personality-type or an analytical personality-type, and wherein the people-oriented personality-type comprises at least one of an influencer personality-type or a supportive personality-type.

22. The system of claim 12, wherein more weight is accorded to a first set of data comprising a first assessor bias indicating a people-oriented personality-type than is accorded to a first set of data comprising a first assessor bias indicating a task-oriented personality-type.

23. The system of claim 12, wherein more weight is accorded to a second set of data comprising a second assessor bias indicating a task-oriented personality-type than is accorded to a second set of data comprising a second assessor bias indicating a people-oriented personality-type.

24. A computer-readable medium for storing at least one computer program for performing a method of assessing workplace safety, the method comprising:
receiving at least one first set of data from a first memory device, each first set of data comprising information indicative of at least one worker's adherence to predetermined safety procedures and further comprising information indicative of a first assessor bias;
receiving at least one second set of data from a second memory device, each second set of data comprising information indicative of at least one workplace environmental parameter and further comprising information indicative of a second assessor bias; and
analyzing the received data based on the information indicative of the first and second assessor biases.
